(19) United States
(12) Patent Application Publication
(10) Pub. No.: US 2020/0253188 A1
(43) Pub. Date: Aug. 13, 2020

(54) Call Carrier

(71) Applicant: Game Scout, LLC, Milan, TN (US)

(72) Inventor: Kyle LYNCH, Milan, TN (US)

(21) Appl. No.: 16/733,406

(22) Filed: Jan. 3, 2020

Related U.S. Application Data
(60) Provisional application No. 62/802,544, filed on Feb. 7, 2019.

(51) Int. Cl. A01M 31/00; A45F 5/00; F41C 27/00; F41C 33/00

(52) U.S. Cl. CPC A01M 31/004; A45F 5/00; A45F 2005/008; F41C 33/002; F41C 27/00

(57) ABSTRACT

A system and method for a call carrier. The carrier has an elongate both which has a left distal end and a right distal end. A closing element secures the left distal end with the right distal end. There is a flap which can hinge open and closed. When the flap is in the closed position it is adjacent to an insert which has at least one pocket. The pocket can be used to house a call. The carrier can be wrapped about a bugle tube allowing a user to carry one or more calls to be used with the bugle tube.

### PRIORITY

The present invention claims priority to U.S. Provisional No. 62/802,544 filed on Feb. 7, 2019, the entirety of which is hereby incorporated by reference.

### BACKGROUND OF THE INVENTION

### Technical Field

The present invention relates to a system and method for carrying and storing a call.

### Description of Related Art

Calls are used to call in animals, game, etc. Typically, a call is simply carried by the user. Consequently, there is a need for a more efficient and practical system for carrying and storing calls.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a perspective view of a bugle tube in one embodiment;

FIG. 2 is a perspective view of a bugle tube with an open flap in one embodiment;

FIG. 3A is a perspective view of the insert in one embodiment;

FIG. 3B is a perspective view of the insert with a backing in one embodiment;

FIG. 4 is a top planar view of the carrier in one embodiment;

FIG. 5 is a perspective view of a carrier on a firearm;

FIG. 6 is a perspective view of a carrier on a forearm;

FIG. 7 is a perspective view of a carrier on a rifle sling.

### DETAILED DESCRIPTION

Several embodiments of Applicant's invention will now be described with reference to the drawings. Unless otherwise noted, like elements will be identified by identical numbers throughout all figures. The invention illustratively disclosed herein suitably may be practiced in the absence of any element which is not specifically disclosed herein.

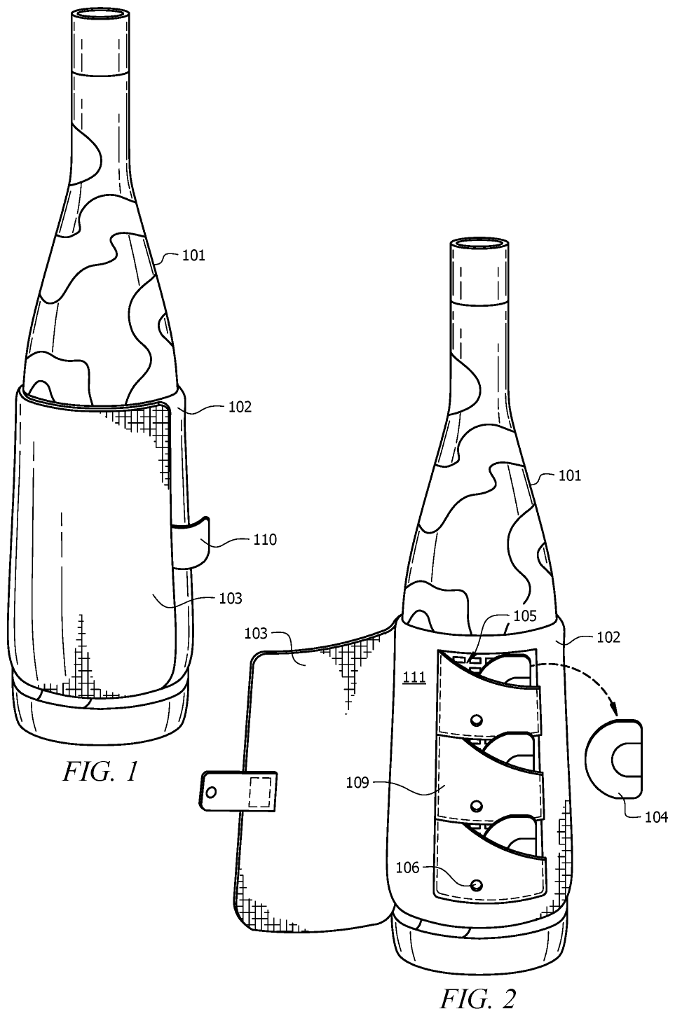

FIG. 1 is a perspective view of a bugle tube in one embodiment. A tube is used in conjunction with a diaphragm call to amplify and project sounds made by the call. A tube is often tapered and ribbed. The tube can comprise a variety of materials, but in one embodiment the tube is polymer.

In one embodiment the user, such as a hunter, places the calls in their mouth and blows air across the call and into the small end of the tube. The tube projects the sound outward, increasing the likelihood that the desired animal will hear the call.

In one embodiment, different calls are used for different animals. In the hunting arena, for example, a user may use a certain call for a turkey, a different call for an elk, etc. With a hollow tube the calls and tubes are often separately stored and separately carried. This increases the likelihood that a call will become lost or damaged. Accordingly, in one embodiment the system offers an opportunity to store one or more calls with the tube.

The tube 101 in FIG. 1 is depicted as being camouflage. This is for illustrative purposes only and should not be deemed limiting. As shown, attached to the tube 101 is a carrier 102. A carrier 102, as used herein, refers to an item which can house one or more calls.

In one embodiment, the carrier 102 installs onto the tube 101 without any modifications to the tube 101. This is an advantage because it allows the carrier 102 to be installed onto pre-existing tubes 101. This means a user need not purchase a new or separate tube 101 in order to benefit from the advantages discussed herein.

The carrier 102 can comprise virtually any material. In one embodiment the carrier 102 comprises a fabric. Virtually any flexible material can be utilized. In other embodiments the carrier 102 can comprise plastic, rubber, metal, and other materials and combinations thereof.

The carrier 102 can install via any method known in the art. In one embodiment the carrier 102 comprises hook and loop attaching devices such as Velcro. This is useful because it allows a single sized carrier 102 to fit on various sized tubes. Hook and loop mechanism often allow the length of the connecting device to vary depending on where the hook and loops are coupled. In other embodiments the carrier 102 comprises loops, ties, or straps which can be adjusted to tighten or loosen to accommodate a tube of varying size.

As shown the carrier has a closed flap 103. The flap 103 is coupled to a tab 110. The user can grasp the tab 110 to pull upon the flap 103. The flap 103 can pivot hingedly relative to the carrier 102. The flap 103 can pivot via fabric such as being sewn to the carrier 102. Or the flap 103 can comprise a separate hinge which couples the flap 103 to the carrier.

The carrier 102 can be installed in various locations along the tube 101. As shown the tube 101 has a narrow top end and tapers to a wider diameter. The tube then has a straight portion where the taper is either very slight or non-existent. This is called the flat portion of the tube. Note, the flat portion does not have to be completely flat as there can still be some taper. In one embodiment the carrier 102 is installed on the flat portion.

The height of the carrier 102, as located parallel to the length of the tube, can vary depending upon the application. The height can be adjusted depending upon the size and number of calls to be housed within the carrier. The height will also depend upon the size of the tube 101.

FIG. 2 is a perspective view of a bugle tube with an open flap in one embodiment. As can be seen, the flap 103 is opened to expose the contents underlying the flap 103.

As depicted is an insert 109 which forms one or more pockets 105. As shown the insert 109 depicts three vertically oriented pockets 105. A pocket 105 is a pouch or holder which can house a call 104. While the pockets 105 are being depicted as being vertically oriented, in other embodiments they can be horizontally oriented. While the figure depicts three pockets stacked vertically, which is perpendicular to the direction the flap 103, in other embodiments the pockets are stacked and aligned parallel to the direction the flap 103 opens. Furthermore, while this carrier depicts housing three pockets, this is for illustrative purposes only and should not deemed limiting. In other embodiments one or more pockets can be included.

The insert 109 can comprise a separate material or it can comprise the same material as the flap 103. As shown, the insert 109 is a separate material which is coupled to the inner layer 111 of the carrier 102.

As shown the insert 109 has three voids or cut-outs which form the pocket 105 which will house the call 104. The void allows the call 104 to be at least partially visible while located in the pocket 105. This has a benefit in that the user can see the various calls 104, and select the desired call 104, without having to remove each call from the pocket 105. In one embodiment the insert 109, and/or the pocket 105, comprises one or more holes 106. The holes 106 allow breathability to the pocket. This allows ventilation to dry calls during transport and storage. This helps ensure long life for call materials which can become wet during usage. If the pockets 105 were not breathable, the calls 104 could become moldy, for example, when stored.

While an insert 109 has been described which forms pockets 105, this is for illustrative purposes only and should not be deemed limiting. In other embodiments, for example, the pockets are formed of pliable mesh. Virtually any known method which can securely house calls and allow for breathability can be utilized in the carrier 102.

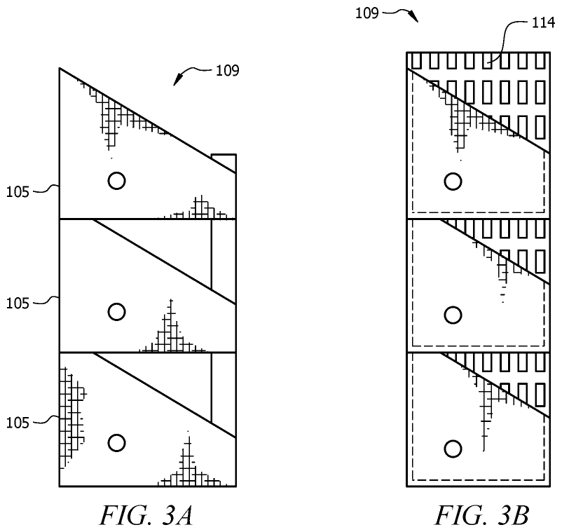

Turning to FIG. 3, FIG. 3A is a perspective view of the insert in one embodiment. The figure shows a flat insert 109. However, when the insert 109 is curved, and coupled to the carrier 102, the various pockets 105 can bulge when housing a call 104.

FIG. 3B is a perspective view of the insert with a backing in one embodiment. The backing 114 is a mesh or other type of material which has a plurality of holes 106. This allows the backing 114 to breathe and allows for moisture to move through the insert 109.

As shown, in some embodiments the insert 109 comprises a backing 114, as in FIG. 3B, whereas in other embodiments the insert 109 does not comprise a backing 114. The backing 114 can be coupled to the insert 109 and added to the inner layer 111. In such an embodiment the backing 114 will lay atop the inner layer 111. In other embodiments, however, there is an absence or void of the inner layer 111 and the backing 114 replaces a portion of the inner layer 111. In such embodiments, there would only be a single layer of the backing 114 as the inner layer 111 would be missing at the location of the backing 114.

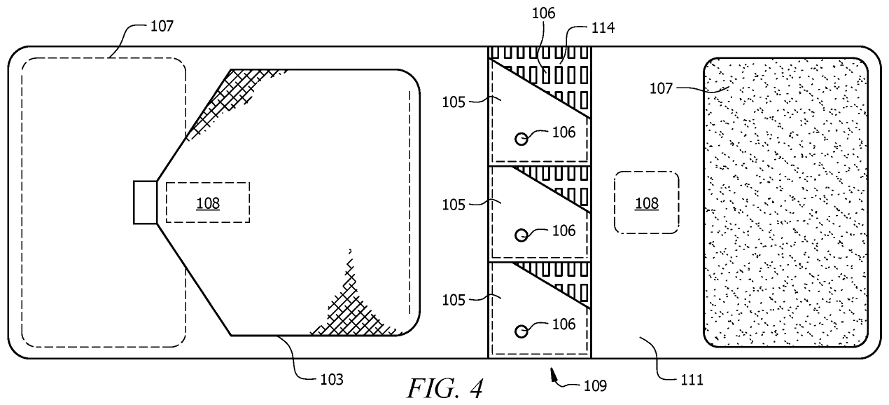

Turning now to FIG. 4, FIG. 4 is a top planar view of the carrier in one embodiment. In this embodiment the carrier 102 is spread out in a flat position. As noted, above, the backing 114 can either be located atop the inner layer 111, or it can be adjacent to the inner layer 111.

As can be seen in FIG. 4, located at the two distal ends are the closing elements 107. These are the elements which can be used to close the carrier 102 around the tube 101. As noted, in one embodiment the carrier 102 is maintained around the tube 101 via friction and requires no alteration to the tube 101. The closing elements 107 can comprise any device known to secure and close two ends. These can include, but are not limited to, hook and loop mechanisms such as Velcro, snaps, buttons, zippers, locks, straps, fittings, magnets, etc.

When installed onto the tube the left side of the carrier 102 will couple with the right distal side. Each side will wrap around the tube 101. In the embodiment wherein the closing elements 107 comprise Velcro, one end, in this case the right end will the inner layer, and the left end will rest atop the inner layer, securing the carrier 102 against the tube 101. As can be seen, there is a large width of the Velcro which allows the carrier 102 to fit around tubes of varying sizes.

As seen in this figure, the flap 103 is open. If the flap 103 were closed the pockets 105 would not be visible.

The flap 103 can be open and closed via any method previously discussed in reference to the closing elements 107. Thus, the flap coupler 108, which secures the flap 103 in the closed position, wherein the pockets are not visible, can comprise Velcro, buckles, buttons, snaps, etc. The flap coupler 108 can comprise any of the closing elements 107 discussed above. The flap coupler 108 can comprise the same or different devices as the closing elements 107 in the same carrier 102. In one embodiment, and as depicted, the flap coupler 108 comprises magnets. In this way the user can simply pull with sufficient force to overcome the magnetic force between the two magnets. While magnets have been discussed, this is for illustrative purposes only and should not be deemed limiting.

To use the carrier 102, the carrier 102 must first be installed to the tube 101 or other carrying device as shown below. The left and right distal ends of the carrier 102 are wrapped against the tube 101. The closing element 107 is manipulated to close the carrier 102 against the tube 101 and secure the carrier 102 in place.

Thereafter, or even before, the user can load one or more calls into the pockets 105. The user can place multiple variable calls in the carrier 102. Then, when the user is ready to use the elk call, for example, the user simply opens the flap 103 and retrieves the call. When the user is finished with the call, the call can simply be placed into the pocket and the flap re-closed.

In use, a user is often traversing very difficult terrain. Thus, rather than hold the call in one hand, the tube 101 in another hand, and somehow carry other hunting equipment, the call can be placed into the carrier 102 which is coupled to a tube 101 while moving to a specific location. This has the benefit of freeing up the user's hand and safely and securely stowing the call for subsequent use.

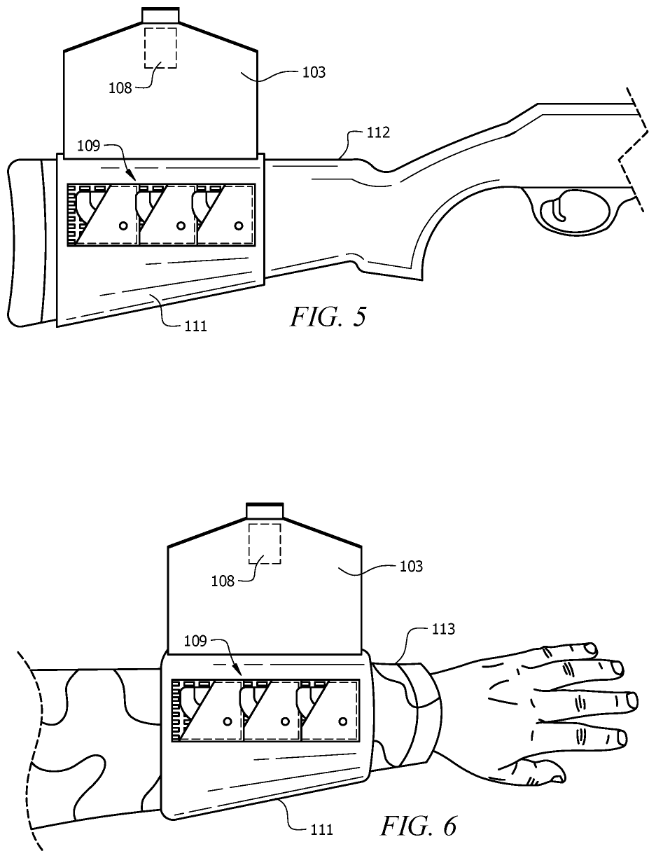

While a carrier has been described as being installed on a tube, this is for illustrative purposes only and should not be deemed limiting. As an example, FIG. 5 is a perspective view of a carrier on a firearm. A firearm, as used herein, refers to any device which propels an object. Thus, a firearm can include, but is not limited to, shotguns, rifles, bows, crossbows, etc. The carrier 102 can be installed in the similar manner as previously described. As shown the carrier 102 is installed on a shotgun stock 112. Like the installation on the tube 101, previously described, when installed the carrier 102 does not interfere with the operation of the shotgun. Further, in one embodiment, no permanent alteration to the firearm is required for the installation of the carrier 102. Instead, the carrier 102 is coupled around a portion of the firearm by connecting the distal ends of the carrier. The user will have access to the calls as previously described. As noted, while a shotgun is described, the carrier 102 can be installed on virtually any firearm including rifles, bows, etc.

FIG. 6 is a perspective view of a carrier 102 installed on a user's forearm 113. The carrier 102 can function as previously described. In one embodiment the carrier 102 is also configured to serve as an armguard against the bowstring for the archery hunter. Thus, in one embodiment the carrier 102 comprises an armguard. More specifically, the carrier 102 can comprise materials and alignment to function as both the carrier 102 and an armguard to protect the hunter from the bowstring.

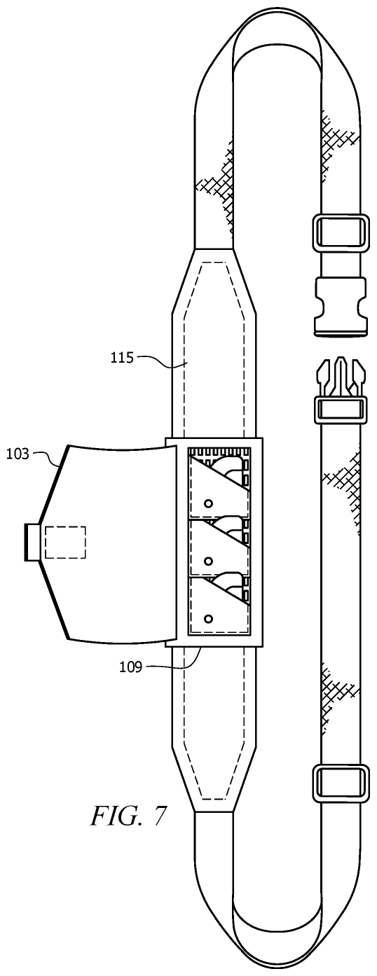

FIG. 7 is a perspective view of a carrier 102 on a rifle sling 115. As shown the carrier 102 has one flap 103 which can be used to secure the calls 104 within the pocket 105. While one flap 103 has been shown, in other embodiments the carrier 102 comprises two or more flaps 103 which allow access to one or more pockets 105. As can be seen, this illustrates the versatility of the carrier 102. While being depicted on a rifle sling 115, the carrier 102 can be installed on virtually any sling, including the sling of a backpack, as but one example.

As noted, the carrier has several advantages. First, in some embodiments the carrier 102 can be installed on pre-existing, and unaltered tubes or firearms. Thus, a hunter can use the same tube they already have and add the carrier to the tube.

Second, for embodiments wherein the carrier 102 is installed on a tube, because the carrier 102 is located on the outer periphery of the tube 101, the effectiveness of the tube 101 is not diminished. Likewise, if the carrier 102 is installed on a firearm, the operation of the firearm is not altered.

Third, as noted, the user can store various calls during transport. The user now needs only carry one item, the tube 101, as opposed to worrying about separately carrying a call.

Fourth, the carrier 102 provides a storage location for various calls. Previously, if a hunter were going to hunt elk, they would have to bring the tube 101 and locate the elk call. With the carrier 102, however, the tube and various calls are in one location. This reduces the likelihood that a call will become lost. Further for hunters, animal watchers, etc., they often have a large amount of gear. Thus, consolidating and simplifying the carrying and storage of this gear is a significant advantage.

Fifth, as noted, in some embodiments the pockets offer s breathable storage compartment. This ensures the calls will properly dry and be in good condition for subsequent use.

While the invention has been particularly shown and described with reference to a preferred embodiment, it will be understood by those skilled in the art that various changes in form and detail may be made therein without departing from the spirit and scope of the invention.

### Additional Description

The following clauses are offered as further description of the disclosed invention.
Clause 1. A system for a carrier, said carrier comprising:
   an elongated carrier comprising a left distal end and a right distal end;
   a closing element which can secure the left distal end to the right distal end;
   a flap which can hinge open and closed;
   wherein when said flap is closed it is adjacent to an insert which houses at least one pocket.
Clause 2. The system of any proceeding or preceding claim further comprising a bugle tube, and wherein said elongated carrier fits around said bugle tube.
Clause 3. The system of any proceeding or preceding claim further comprising at least one call.
Clause 4. The system of any proceeding or preceding claim wherein said insert further comprises a backing, and wherein said backing comprises a plurality of holes.
Clause 5. The system of any proceeding or preceding claim wherein said backing comprises a mesh material.
Clause 6. The system of any proceeding or preceding claim wherein said pocket comprises at least one hole.
Clause 7. The system of any proceeding or preceding claim wherein said insert comprises at least three pockets vertically aligned.
Clause 8. The system of any proceeding or preceding claim wherein said flap further comprises a flap coupler to keep the flap closed adjacent to said insert.
Clause 9. The system of any proceeding or preceding claim wherein said insert comprises more than one pocket, and wherein said pocket comprises at least two dissimilar calls.
Clause 10. The system of any proceeding or preceding claim coupled to a firearm.
Clause 11. The system of any proceeding or preceding claim coupled to a rifle sling.
Clause 12. The system of any proceeding or preceding claim wherein said carrier further comprises an inner layer, and wherein said insert is coupled to said inner layer.
Clause 13. The system of any proceeding or preceding claim wherein said pocket comprises a void such that said at least one call is at least partially visible when located in said pocket.
Clause 14. The system of any proceeding or preceding claim wherein said carrier further comprises an armguard.

What is claimed is:

1. A system for a carrier, said carrier comprising:
an elongated carrier comprising a left distal end and a right distal end;
a closing element which can secure the left distal end to the right distal end;
a flap which can hinge open and closed;
wherein when said flap is closed it is adjacent to an insert which houses at least one pocket.

2. The system of claim 1 further comprising a bugle tube, and wherein said elongated carrier fits around said bugle tube.

3. The system of claim 1 further comprising at least one call.

4. The system of claim 1 wherein said insert further comprises a backing, and wherein said backing comprises a plurality of holes.

5. The system of claim 4 wherein said backing comprises a mesh material.

6. The system of claim 1 wherein said pocket comprises at least one hole.

7. The system of claim 1 wherein said insert comprises at least three pockets vertically aligned.

8. The system of claim 1 wherein said flap further comprises a flap coupler to keep the flap closed adjacent to said insert.

9. The system of claim 1 wherein said insert comprises more than one pocket, and wherein said pocket comprises at least two dissimilar calls.

10. The system of claim 1 coupled to a firearm.

11. The system of claim 1 coupled to a rifle sling.

12. The system of claim 1 wherein said carrier further comprises an inner layer, and wherein said insert is coupled to said inner layer.

13. The system of claim 3 wherein said pocket comprises a void such that said at least one call is at least partially visible when located in said pocket.

14. The system of claim 1 wherein said carrier further comprises an armguard.
